(19) United States
(12) Patent Application Publication
(10) Pub. No.: US 2023/0159743 A1
(43) Pub. Date: May 25, 2023

(54) HEAT-CURABLE EPOXY RESIN COMPOSITION AND HEAT-CURABLE EPOXY RESIN SHEET

(71) Applicant: Shin-Etsu Chemical Co., Ltd., Tokyo (JP)

(72) Inventors: Naoyuki KUSHIHARA, Annaka-shi (JP); Masahiro KANETA, Annaka-shi (JP); Kazuaki SUMITA, Annaka-shi (JP)

(73) Assignee: Shin-Etsu Chemical Co., Ltd., Tokyo (JP)

(21) Appl. No.: 17/988,896

(22) Filed: Nov. 17, 2022

(30) Foreign Application Priority Data
Nov. 24, 2021 (JP) 2021-189863

(51) Int. Cl. C08L 63/00

(52) U.S. Cl. CPC C08L 63/00; C08L 2205/025

(57) ABSTRACT

Provided is a heat-curable epoxy resin composition having an excellent flexibility when in an uncured state, an excellent storage stability and moldability, a high glass-transition temperature when in the state of a cured product, and an excellent adhesive force to a metal substrate, particularly to a Cu (alloy) substrate. The heat-curable epoxy resin composition contains:
(A) a crystalline epoxy resin;
(B) a non-crystalline epoxy resin solid at 25° C.;
(C) a phenolic compound;
(D) a nitrogen atom-containing curing accelerator;
(E) a reaction inhibitor; and
(F) an inorganic filler.

### BACKGROUND OF THE INVENTION

### Field of the Invention

The present invention relates to a heat-curable epoxy resin composition capable of providing a resin sheet that is superior in flexibility when in an uncured state, and is also superior in storage stability and moldability.

### Background Art

Since epoxy resin compositions are superior in adhesive force, heat resistance and electric properties, they are used as adhesive agents and encapsulation materials in fields of, for example, electric and electronic equipment parts and automotive parts.

In recent years, sheet-shaped encapsulation materials are under consideration for performing batch-molding of large-size substrates and wafers. Since general sheet-shaped materials are easy to break, reports have been made on adding a thermoplastic resin thereto (JP-A-2016-213391). However, since the glass-transition temperature of a cured sheet material will decrease by adding a thermoplastic resin, the use application of such material will be limited, which has been one of the problems thereof.

Further, when stored in a frozen condition, a sheet material will break easily as the resin components therein will harden; refrigeration storage or normal-temperature storage are thus recommended. In order to improve storage stability, there has been proposed an epoxy resin composition employing a phenolic compound as a curing agent; and a borate salt with a phosphorus compound, as a curing accelerator (Japanese Patent No. 6857836 and JP-A-2003-292732). While an excellent storage stability may be achieved by using, as a curing accelerator, a borate salt with a phosphorus compound, there are problems such as a deteriorated moldability and an insufficient adhesive force to metal substrates.

### SUMMARY OF THE INVENTION

Thus, it is an object of the present invention to provide a heat-curable epoxy resin composition having an excellent flexibility when in an uncured state, an excellent storage stability and moldability, a high glass-transition temperature when in the state of a cured product, and an excellent adhesive force to a metal substrate, particularly to a Cu (alloy) substrate.

The inventors of the present invention diligently conducted a series of studies to solve the above problems, and completed the invention as follows. That is, the inventors found that a heat-curable epoxy resin composition containing a crystalline epoxy resin, a non-crystalline epoxy resin solid at 25° C., a phenolic compound, a nitrogen atom-containing curing accelerator, a reaction inhibitor and an inorganic filler, was superior in flexibility, storage stability and moldability, and was also able to provide a cured product superior in heat resistance reliability and moisture resistance reliability.

Specifically, the present invention is to provide a heat-curable epoxy resin composition containing the following components (A) to (F).

[1]

A heat-curable epoxy resin composition comprising:
(A) a crystalline epoxy resin;
(B) a non-crystalline epoxy resin solid at 25° C.;
(C) a phenolic compound;
(D) a nitrogen atom-containing curing accelerator;
(E) a reaction inhibitor; and
(F) an inorganic filler.
   [2]

The heat-curable epoxy resin composition according to [1], wherein the component (E) is at least one selected from the group consisting of boric acid, a boric ester compound and a phosphite ester compound.

[3]

The heat-curable epoxy resin composition according to [2], wherein the boric ester compound and the phosphite ester compound each contains a monovalent hydrocarbon group having 1 to 10 carbon atoms.

[4]

The heat-curable epoxy resin composition according to any one of [1] to [3], wherein the component (D) is a urea-based curing accelerator or an imidazole-based curing accelerator.

[5]

The heat-curable epoxy resin composition according to any one of [1] to [4], wherein the component (E) is contained in an amount of 0.01 to 5 parts by mass per a total of 100 parts by mass of the components (A), (B) and (C).

[6]

The heat-curable epoxy resin composition according to any one of [1] to [5], wherein the component (F) is a spherical silica.

[7]

A heat-curable epoxy resin sheet wherein the heat-curable epoxy resin composition according to any one of [1] to [6] is molded into the shape of a sheet.

[8]

The heat-curable epoxy resin sheet according to [7], wherein the heat-curable epoxy resin sheet has a thickness of 0.1 to 5 mm.

Since the heat-curable epoxy resin composition of the present invention has an excellent flexibility when in an uncured state, it can be easily molded into the shape of a sheet; and the composition also has an excellent storage stability. Further, the composition provides a cured product superior in heat resistance reliability and moisture resistance reliability. Thus, the heat-curable epoxy resin composition of the present invention is suitable for use in a sheet-shaped encapsulation material for performing batch-molding of large-size substrates and wafers.

### DETAILED DESCRIPTION OF THE INVENTION

The heat-curable epoxy resin composition of the present invention is described in greater detail hereunder.

### (A) Crystalline Epoxy Resin

A component (A) is an epoxy resin having a crystallizability, and a known crystalline epoxy resin may be employed. There are no restrictions on such crystalline epoxy resin in terms of molecular structure, molecular weight or the like so long as the epoxy resin is an epoxy resin having a crystallizability. For example, there may be listed a biphenyl-type epoxy resin, a bisphenol-type epoxy resin and a stilbene-type epoxy resin. Any one kind of these epoxy resins may be used alone, or two or more kinds of them may be used in combination. Preferred is a bisphenol A-type epoxy resin or a bisphenol F-type epoxy resin. Here, in the present invention, a “resin having a crystallizability” refers to a type of epoxy resin that convers from solid to liquid under a temperature not lower than its melting point, whereby exhibiting a high fluidity; and is crystallized under a temperature lower than the melting point. Especially, preferred is a bisphenol A-type epoxy resin or bisphenol F-type epoxy resin that is crystallized under a normal temperature, and particularly has a melting point of 40° C. or higher.

In the heat-curable epoxy resin composition of the present invention, it is preferred that the component (A) be contained in an amount of 5 to 35 parts by mass, more preferably 8 to 33 parts by mass, even more preferably 10 to 30 parts by mass, per a total of 100 parts by mass of the components (A), (B) and (C). When the amount of the component (A) is not smaller than 5 parts by mass, a sufficient flexibility can be imparted to a sheet obtained by molding. When the amount of the component (A) is not larger than 35 parts by mass, while a sufficient flexibility can be maintained, there will be no concerns that a tackiness may increase, a retaining force as a sheet may deteriorate, or the glass-transition temperatures of the resins composing the sheet may be too low.

### (B) Non-Crystalline Epoxy Resin Solid at 25° C.

A component (B) is a component other than the component (A), and is a non-crystalline epoxy resin being a solid at 25° C.; a known non-crystalline epoxy resin may be used as the component (B). There are no restrictions on such epoxy resin solid at 25° C. in terms of molecular structure, molecular weight or the like so long as this epoxy resin is solid at 25° C. and non-crystalline. For example, there may be listed a non-crystalline bisphenol A-type epoxy resin; a non-crystalline bisphenol F-type epoxy resin; a biphenol-type epoxy resin such as a 3,3′,5,5′-tetramethyl-4,4′-biphenol-type epoxy resin and a 4,4′-biphenol-type epoxy resin; a phenol novolac-type epoxy resin; a cresol novolac-type epoxy resin; a bisphenol A novolac-type epoxy resin; a stilbene-type epoxy resin; a triazine skeleton-containing epoxy resin; a fluorene skeleton-containing epoxy resin; a trisphenol alkane-type epoxy resin; a biphenyl-type epoxy resin; a xylylene-type epoxy resin; a biphenyl aralkyl-type epoxy resin; a naphthalene-type epoxy resin; a dicyclopentadiene-type epoxy resin; an alicyclic epoxy resin; diglycidylether compounds of polycyclic aromatics such as multifunctional phenols and anthracene; phosphorous-containing epoxy resins with a phosphorous compound(s) being introduced into any of the above examples; and a silicone-modified epoxy resin.

In the heat-curable epoxy resin composition of the present invention, it is preferred that the component (B) be contained in an amount of 15 to 75 parts by mass, more preferably 20 to 70 parts by mass, per the total of 100 parts by mass of the components (A), (B) and (C).

Further, as for a quantity ratio between the components (A) and (B), it is preferred that the component (B) be in an amount of 30 to 90 parts by mass, more preferably 40 to 85 parts by mass, even more preferably 50 to 85 parts by mass, per a total of 100 parts by mass of the components (A) and (B). When the component (B) is in an amount of not smaller than 30 parts by mass, a favorable moldability will be exhibited; when it is in an amount of not larger than 90 parts by mass, there will be no concerns that the mechanical properties of a cured product obtained will be impaired.

### (C) Phenolic Compound

A component (C) is a phenolic compound, and a known phenolic compound may be used. There are no restrictions on such phenolic compound in terms of molecular structure, molecular weight or the like. For example, there may be listed a phenol novolac resin, a cresol novolac resin, a phenol aralkyl resin, a naphthol aralkyl resin, a trisphenol alkane resin, a terpene-modified phenolic resin, and a dicyclopentadiene-modified phenolic resin. Any one kind of these compounds may be used alone, or two or more kinds of them may be used in combination. These phenolic compounds may be selected with no restrictions imposed on molecular weight, softening point, hydroxyl group quantity or the like; preferred are those with low softening points and relatively low viscosities.

In the heat-curable epoxy resin composition of the present invention, it is preferred that the component (C) be contained in such an amount that a molar ratio of the phenolic hydroxyl groups in the component (C) per a total of 1 mol of the epoxy groups in the components (A) and (B) is 0.5 to 2, more preferably 0.7 to 1.5. When the molar ratio is within the above ranges, there will be no concerns that the curability etc. of the heat-curable epoxy resin composition and the mechanical properties etc. of the cured product may be impaired.

Further, in the heat-curable epoxy resin composition of the present invention, it is preferred that a total amount of the components (A), (B) and (C) be 10 to 80% by mass, more preferably 15 to 70% by mass, even more preferably 15 to 60% by mass.

### (D) Nitrogen Atom-Containing Curing Accelerator

A component (D) is a nitrogen atom-containing curing accelerator, and is added to promote the curing of the epoxy resins as the components (A) and (B) and the phenolic compound (C). Examples of such curing accelerator include a tertiary amine such as triethylamine, benzyldimethylamine, α-methylbenzyldimethylamine and 1,8-diazabicyclo[5.4.0]undecene-7; an imidazole compound (imidazole-based curing accelerator) such as 2-methylimidazole, 2-phenylimidazole, 2-phenyl-4-methylimidazole, 2-phenyl-4,5-dihydroxymethylimidazole, and 2,4-diamino-6-[2′-methylimidazolyl-(1′)]-ethyl-s-triazine isocyanuric acid adduct; and a urea-based curing accelerator such as 1,1-dimethylurea, 1,1,3-trimethylurea, 1,1-dimethyl-3-ethylurea, 1,1-dimethyl-3-phenylurea, 1,1-diethyl-3-methylurea, 1,1-diethyl-3-phenylurea, 1,1-dimethyl-3-(3,4-dimethyl phenyl)urea, 1,1-dimethyl-3-(p-chlorophenyl)urea, 3-(3,4-dichlorophenyl)-1,1-dimethylurea (DCMU), and N′-[3-[[[(dimethylamino)carbonyl]amino]methyl]-3,5,5-trimethylcyclohexyl]-N,N-dimethylurea.

It is preferred that the curing accelerator be contained in an amount of 0.05 to 20 parts by mass, particularly preferably 0.1 to 15 parts by mass, per the total of 100 parts by mass of the components (A), (B) and (C). When the curing accelerator is in an amount of 0.05 to 20 parts by mass, there will be no concerns that a balance between the heat resistance and moisture resistance of the cured product of the composition may deteriorate, and that a curing speed at the time of molding may be either extremely slow or extremely fast.

### (E) Reaction Inhibitor

A component (E) is a reaction inhibitor, and is added to improve the storage stability of the heat-curable epoxy resin composition. There are no particular restrictions on the reaction inhibitor as the component (E); any known reaction inhibitor may be used. Examples of such reaction inhibitor include boric acid, a boric ester compound, an aluminum chelate compound, a phosphite ester compound and an organic acid. Particularly, preferred are a boric ester compound and a phosphite ester compound. Further, as for such boric ester compound and phosphite ester compound, preferred are those each containing a monovalent hydrocarbon group having 1 to 10 carbon atoms.

Examples of the boric ester compound include trimethyl borate, triethyl borate, tri-n-propyl borate, triisopropyl borate, tri-n-butyl borate, tripentyl borate, triallyl borate, trihexyl borate, tricyclohexyl borate, trioctyl borate, trinonyl borate, tridecyl borate, tridodecyl borate, trihexadecyl borate, trioctadecyl borate, tris(2-ethylhexyloxy)borane, bis(1,4,7,10-tetraoxaundecyl)(1,4,7,10,13)-pentaoxatetradecyl)(1,4,7-trioxaundecyl)borane, tribenzyl borate, triphenyl borate, tri-o-tolylborate, tri-m-tolylborate, and triethanolamine borate.

Examples of the aluminum chelate compound include triethyl aluminate, tripropyl aluminate, triisopropyl aluminate, tributyl aluminate, and trioctyl aluminate.

Examples of the phosphite ester compound include monomethyl phosphite, dimethyl phosphite, monoethyl phosphite, diethyl phosphite, monobutyl phosphite, dibutyl phosphite, monolauryl phosphite, dilauryl phosphite, monooleyl phosphite, dioleyl phosphite, monophenyl phosphite, diphenyl phosphite, mononaphthyl phosphite, dinaphthyl phosphite, di-o-tolyl phosphite, di-m-tolyl phosphite, di-p-tolyl phosphite, di-p-chlorophenyl phosphite, di-p-bromophenyl phosphite, and di-p-fluorophenyl phosphite.

Any one kind of these reaction inhibitors may be used alone, or two or more kinds of them may be used in combination.

It is preferred that the reaction inhibitor (E) be contained in an amount of 0.01 to 5 parts by mass, particularly preferably 0.05 to 3 parts by mass, per the total of 100 parts by mass of the components (A), (B) and (C). When the reaction inhibitor (E) is in an amount of 0.01 to 5 parts by mass, there will be no concerns that the balance between the heat resistance and moisture resistance of the cured product of the composition may deteriorate, and that the curing speed at the time of molding may be extremely slow.

### (F) Inorganic Filler

A component (F) is an inorganic filler, and is added to improve the strength of the heat-curable epoxy resin composition of the present invention. As the inorganic filler of the component (F), there may be used those that are normally added to epoxy resin compositions and silicone resin compositions. For example, there may be listed silicas such as a spherical silica, a molten silica and a crystalline silica; inorganic nitrides such as silicon nitride, aluminum nitride and boron nitride; and alumina, glass fibers as well as glass particles. Here, in terms of, for example, achieving a superior reinforcement effect and suppressing the warpage of the cured product obtained, it is preferred that the component (F) be that containing silicas, more preferably that containing a spherical silica.

There are no particular restrictions on an average particle size of the inorganic filler as the component (F); the average particle size thereof is preferably 0.1 to 40 more preferably 0.5 to 40 In the present invention, the average particle size is a value obtained as a mass average value D50 (or median diameter) in a particle size distribution measurement that is carried out by a laser diffraction method.

Further, when producing the heat-curable epoxy resin composition of the present invention, from the perspective of achieving a higher fluidity of the epoxy resin composition, there may be used, as the component (F), a combination of inorganic fillers from multiple particle size ranges. In such case, it is preferred that there be used combinations of spherical silicas from a minute region of 0.1 to 3 μm, a middle particle size region of 3 to 7 μm, and a coarse region of 10 to 40 μm; as a result of combining them, it is more preferred that the average particle size of the component (F) as a whole be in the range of 0.5 to 40 μm. In order to achieve an even higher fluidity, it is preferred that there be used spherical silicas with even larger average particle sizes.

It is preferred that the inorganic filler (F) be previously surface-treated with a coupling agent such as a silane coupling agent and a titanate coupling agent. Examples of such coupling agent include silane coupling agents such as an epoxysilane, an aminosilane and a mercaptosilane, of which the epoxysilane may for example be γ-glycidoxypropyltrimethoxysilane, γ-glycidoxypropylmethyldiethoxysilane, and β-(3,4-epoxycyclohexyl)ethyltrimethoxysilane; the aminosilane may for example be N-β(aminoethyl)-γ-aminopropyltrimethoxysilane, a reactant of imidazole and γ-glycidoxypropyltrimethoxysilane, γ-aminopropyltriethoxysilane, and N-phenyl-γ-aminopropyltrimethoxysilane; and the mercaptosilane may for example be γ-mercaptopropyltrimethoxysilane and γ-(thiiranylmethoxy)propyltrimethoxysilane. Here, there are no particular restrictions on the amount of the coupling agent used for surface treatment and a surface treatment method.

It is preferred that the inorganic filler (F) be contained in an amount of 5 to 94% by mass, more preferably 10 to 92% by mass, even more preferably 20 to 90% by mass, particularly preferably 50 to 90% by mass, with respect to the whole heat-curable epoxy resin composition.

### Other Additives

The epoxy resin composition of the present invention can be obtained by combining given amounts of the components (A) to (F); if necessary, other additives may also be added on the premise that the purposes and effects of the present invention will not be impaired. Examples of such additives include an adhesion aid, a flame retardant, an ion-trapping agent, a mold release agent, a stress-reducing agent and a colorant.

The flame retardant is added to impart a flame retardancy, and any known flame retardant may be used with no particular restrictions being imposed thereon. Examples of such flame retardant include a phosphazene compound, a silicone compound, a zinc molybdate-supported talc, a zinc molybdate-supported zinc oxide, aluminum hydroxide, magnesium hydroxide, and molybdenum oxide.

The adhesion aid is added to for example improve an adhesiveness to a silicon wafer, a metal substrate or an organic substrate. A known adhesion aid may be used with no particular restrictions being imposed thereon. For example, there may be added a coupling agent such as a silane coupling agent and a titanate coupling agent, of which a silane coupling agent is preferred.

Examples of such coupling agent include an epoxy functional alkoxysilane such as γ-glycidoxypropyltrimethoxysilane, γ-glycidoxypropylmethyldiethoxysilane, and β-(3,4-epoxycyclohexyl)ethyltrimethoxysilane; an amino functional alkoxysilane such as N-β-(aminoethyl)-γ-aminopropyltrimethoxysilane, γ-aminopropyltriethoxysilane, and N-phenyl-γ-aminopropyltrimethoxysilane; a mercapto functional alkoxysilane such as γ-mercaptopropyltrimethoxysilane; and an amine functional alkoxysilane such as γ-aminopropyltrimethoxysilane and N-2-(aminoethyl)-3-aminopropyltrimethoxysilane.

The ion-trapping agent is added to prevent heat deterioration and moisture-absorption deterioration by capturing the ion impurities contained in the resin composition; any known ion-trapping agent may be used with no particular restrictions being imposed thereon. Examples of such ion-trapping agent include hydrotalcites, a bismuth hydroxide compound, and a rare-earth oxide.

The mold release agent is added to improve a mold releasability at the time of molding; any known mold release agent may be used with no particular restrictions being imposed thereon. Examples of such mold release agent include waxes such as carnauba wax, rice wax, polyethylene, oxidized polyethylene, montanic acid, and an ester compound of montanic acid with for example a saturated alcohol, 2-(2-hydroxyethylamino)-ethanol, ethyleneglycol, glycerin or the like; and stearic acid, stearic acid ester, stearic acid amide, ethylenebisstearic acid amide, as well as a copolymer of ethylene and vinyl acetate. Any one kind of these mold release agents may be used alone, or two or more kinds of them may be used in combination.

The stress-reducing agent is added to reduce the stress of the heat-curable epoxy resin composition; any known stress-reducing agent may be used with no particular restrictions being imposed thereon. Examples of such stress-reducing agent include a silicone compound such as a silicone oil, a silicone resin, a silicone-modified epoxy resin and a silicone-modified phenolic resin; and a thermoplastic elastomer such as a styrene resin and an acrylic resin. Any one kind of these stress-reducing agents may be used alone, or two or more kinds of them may be used in combination.

### Method for Producing Heat-Curable Epoxy Resin Composition

The heat-curable epoxy resin composition of the present invention can be obtained by combining, at given compounding ratios, the epoxy resins as the components (A) and (B), the phenolic compound (C), the nitrogen atom-containing curing accelerator (D), the reaction inhibitor (E), the inorganic filler (F) and other additives, and then sufficiently uniformly mixing them with a mixer or the like. A heat-curable epoxy resin composition sheet is then obtained by molding such epoxy resin composition into the shape of a sheet. Molding may for example be performed by a T-die extrusion method employing a biaxial extruder with a T-die being provided at the end thereof. Instead, a melting and mixing treatment may be performed with a heated roll, a kneader, an extruder or the like, followed by cooling so as to solidify the mixture before crushing it into an appropriate size(s) to obtain a crushed product of the heat-curable epoxy resin composition, whereby the crushed product is then heated and melted at 70 to 120° C. between pressing members so as to be molded into the shape of a sheet by compression. The heat-curable epoxy resin sheet of the present invention preferably has a thickness of 0.1 to 5.0 mm, more preferably 0.15 to 3.0 mm.

The sheet obtained from the heat-curable epoxy resin composition of the present invention is superior in flexibility in an uncured state. Further, this composition has a favorable handling property, and can be turned, by curing, into a heat-curable epoxy resin sheet also having an excellent storage stability and moldability while having a high glass-transition temperature. There are no particular restrictions on a curing condition(s) for the heat-curable epoxy resin sheet of the present invention.

### Working Examples

The present invention is described in greater detail hereunder with reference to working and comparative examples; the present invention shall not be limited to the following working examples.

Raw materials used in the working and comparative examples are as follows.

### (A) Crystalline Epoxy Resin

(A1): Bisphenol A-type epoxy resin (YL-6810 by Mitsubishi Chemical Corporation, epoxy equivalent 170, melting point 45° C.)

### (B) Non-Crystalline Epoxy Resin Solid at 25° C.

(B1): Cresol novolac-type epoxy resin (EPICLON N-665 by DIC Corporation, epoxy equivalent 210, softening point 65° C.)

(B2): Trisphenolmethane epoxy resin (EPPN-501H by Nippon Kayaku Co., Ltd., epoxy equivalent 168, softening point 53° C.)

(B3): Biphenyl aralkyl-type epoxy resin (NC-3000H by Nippon Kayaku Co., Ltd., epoxy equivalent 272, softening point 70° C.)

### (C) Phenolic Compound

(C1): Phenol novolac resin (BRG-555 by Aica Kogyo Co. Ltd., hydroxyl group equivalent 107)

(C2): Trisphenolmethane resin (MEH-7500 by Meiwa Plastic Industries, Ltd., hydroxyl group equivalent 97)

(C3): Phenol biphenyl aralkyl resin (MEH-7851SS by Meiwa Plastic Industries, Ltd., hydroxyl group equivalent 199)

### (D) Nitrogen Atom-Containing Curing Accelerator

(D1): 2-phenyl-4,5-dihydroxymethylimidazole (2PHZ-PW by SHIKOKU CHEMICALS CORPORATION)

(D2): 2,4-diamino-6-[2′-methylimidazolyl-(1′)]-ethyl-s-triazine isocyanuric acid adduct (2MAOK-PW by SHIKOKU CHEMICALS CORPORATION)

(D3): Aliphatic dimethylurea (U-CAT 3513N by San-Apro Ltd.)

(D′) Nitrogen atom-free curing accelerator (for comparison)

(D′1): Triphenylphosphine (TPP by HOKKO CHEMICAL INDUSTRY CO., LTD.)

### (E) Reaction Inhibitor

(E1): Trimethyl borate (TMB by DAIHACHI CHEMICAL INDUSTRY CO., LTD.)

(E2): Tri-n-butyl borate (TBB by DAIHACHI CHEMICAL INDUSTRY CO., LTD.)

### (F) Inorganic Filler

(F1): Spherical molten silica (molten spherical silica with mass average particle size of 14 μm, by TATSUMORI LTD.)

### Other Components

Amine compound: 4,4′-diaminodiphenylmethane (DDM by Tokyo Chemical Industry Co., Ltd.)

### Working Examples 1 to 11; Comparative Examples 1 to 5

After preliminarily mixing the above components at the compounding ratios (parts by mass) shown in Tables 1-1 and 1-2 with a Henschel mixer, a heat-curable epoxy resin composition was then obtained using a biaxial extruder. In the working and comparative examples below, the component (C) is added in an amount at which the molar ratio of the phenolic hydroxyl groups in the component (C) per the total of 1 mol of the epoxy groups in the components (A) and (B) is 1.0.

### Flexibility of Uncured Resin Sheet

The heat-curable epoxy resin composition obtained by the above method was molded into the shape of a sheet having a size of 100 mm×100 mm and a thickness of 0.5 mm; a bending test was then performed on such sheet in an uncured state. Here, the flexibility of the uncured resin sheet was evaluated in such a manner that “∘” was given to examples where the sheet was able to be folded in half without causing breakages, and that “x” was given to examples where the sheet broke when bended. The results thereof are shown in Tables 1-1 and 1-2.

### Glass-Transition Temperature

Using a mold manufactured in accordance with the EMMI standard, the heat-curable epoxy resin sheet having the thickness of 0.5 mm was cured under conditions of: molding temperature 175° C.; molding pressure 6.9 N/mm²; molding time 180 sec. The cured resin sheet was then subjected to post curing at 180° C. for four hours. The glass-transition temperature and thermal expansion coefficient of a test piece produced from the post-cured cured product were measured by TMA (TMA8310 by Rigaku Corporation).

Changes in dimensions of the test piece from 25° C. to 300° C. were measured with a temperature rise rate of the temperature rise program being set to 5° C./min, and with a constant load of 49 mN being applied to the test piece of the post-cured cured product. The correlation between such changes in dimensions and temperature was plotted in a graph. The glass-transition temperatures in the working and comparative examples were then obtained from such graph of the changes in dimensions and temperature. The results thereof are shown in Tables 1-1 and 1-2.

### Storage Stability

With the aid of a Koka-type flow tester (flow tester, model CFT-500 by SHIMADZU CORPORATION), the lowest melt viscosity of each heat-curable epoxy resin composition was measured under a pressure of 25 kgf and at a temperature of 175° C., using a nozzle having a diameter of 1 mm. Further, after leaving each heat-curable epoxy resin composition in a thermostatic bath of 50° C. for 72 hours, the lowest melt viscosity of the composition thus treated was also measured under similar conditions. A ratio in percentage of the lowest melt viscosity of the composition after it was left at 50° C. for 72 hours to the lowest melt viscosity thereof immediately after its production was regarded as a storage stability; the results thereof are shown in Tables 1-1 and 1-2.

### Bending Strength

In accordance with JIS K6911, each heat-curable epoxy resin composition was subjected to transfer molding at 175° C. and a molding pressure of 6.9 MPa for 180 sec, followed by performing post curing at 180° C. for four hours to obtain a test piece having a size of 100 mm×100 mm and a thickness of 4 mm. The test piece was then subjected to a three-point bending test using an autograph by SHIMADZU CORPORATION, thus obtaining a bending strength of the test piece. The results thereof are shown in Tables 1-1 and 1-2.

### Adhesive Force

Each heat-curable epoxy resin composition in the working and comparative examples was subjected to transfer molding at 175° C. and a molding pressure of 6.9 MPa for 180 sec, on a Cu alloy (Olin C7025)-made substrate having a size of 15 mm×15 mm and a thickness of 0.15 mm, whereby the composition was molded into a molded product having a base area of 10 mm² and a height of 3.5 mm, followed by performing post curing at 180° C. for four hours to obtain a test piece. Next, a die shear tester (by Nordson DAGE) was used to apply a shearing force to such molded product at a shearing rate of 0.2 mm/s, and there was measured a shearing strength (adhesive force) when the molded product was peeled away from the surface of the substrate. The results thereof are shown in Tables 1-1 and 1-2.

TABLE 1-1

| | | Working | Working | Working | Working | Working | Working | Working | Working |
|---|---|---|---|---|---|---|---|---|---|
| | | example 1 | example 2 | example 3 | example 4 | example 5 | example 6 | example 7 | example 8 |
| Crystalline epoxy resin(A1) | | 10 | 10 | 10 | 10 | 10 | 20 | 30 | 10 |
| Solid epoxy resin(B1) | | | | | | | | | 15.7 |
| Solid epoxy resin(B2) | | 52.6 | 52.6 | 52.6 | 52.6 | 52.6 | 44 | 34 | 36.7 |
| Solid epoxy resin(B3) | | | | | | | | | |
| Phenolic compound(C1) | | 18.7 | 18.7 | 18.7 | 18.7 | 18.7 | | | |
| Phenolic compound(C2) | | 18.7 | 18.7 | 18.7 | 18.7 | 18.7 | 36 | 36 | 37.6 |
| Phenolic compound(C3) | | | | | | | | | |
| Nitrogen atom-containing | | 1 | | | 1 | 1 | 1 | 1 | 1 |
| curing accelerator(D1) | | | | | | | | | |
| Nitrogen atom-containing | | | 2 | | | | | | |
| curing accelerator (D2) | | | | | | | | | |
| Nitrogen atom-containing | | | | 3 | | | | | |
| curing accelerator (D3) | | | | | | | | | |
| Nitrogen atom-free | | | | | | | | | |
| curing accelerator (D′1) | | | | | | | | | |
| Reaction inhibitor(E1) | | 0.2 | 0.2 | 0.2 | 0.4 | | 0.2 | 0.2 | 0.2 |
| Reaction inhibitor(E2) | | | | | | 1 | | | |
| Inorganic filler(F1) | | 500 | 500 | 500 | 500 | 500 | 500 | 500 | 500 |
| Content ratio of inorganic filler(F) | % by | 83.2 | 83.0 | 82.9 | 83.1 | 83.1 | 83.2 | 83.2 | 83.2 |
| | mass | | | | | | | | |
| Amine compound | | | | | | | | | |
| Flexibility of uncured resin sheet | | ◯ | ◯ | ◯ | ◯ | ◯ | ◯ | ◯ | ◯ |
| Glass-transition temperature | ° C. | 200 | 200 | 190 | 195 | 200 | 220 | 210 | 190 |
| Storage stability | % | 91 | 90 | 95 | 98 | 90 | 89 | 90 | 91 |
| Bending strength | MPa | 121 | 126 | 119 | 133 | 135 | 130 | 136 | 128 |
| Adhesive force | MPa | 11.2 | 12.1 | 10.6 | 12.8 | 12.1 | 10.1 | 10.6 | 11.5 |

TABLE 1-2

| | | Working | Working | Working | Comparative | Comparative | Comparative | Comparative | Comparative |
|---|---|---|---|---|---|---|---|---|---|
| | | example 9 | example 10 | example 11 | example 1 | example 2 | example 3 | example 4 | example 5 |
| Crystalline epoxy resin(A1) | | 10 | 10 | 10 | | 10 | 10 | 10 | 10 |
| Solid epoxy resin(B1) | | | 52 | 56.3 | | 56.3 | 56.3 | 90 | 70.5 |
| Solid epoxy resin(B2) | | 37.5 | | | 62.6 | | | | |
| Solid epoxy resin(B3) | | | | | | | | | |
| Phenolic compound(C1) | | 16.1 | 26.6 | 23.6 | 18.7 | 23.6 | 23.6 | | |
| Phenolic compound(C2) | | 36.4 | | 10.1 | 18.7 | 10.1 | 10.1 | | |
| Phenolic compound(C3) | | | 11.4 | | | | | | |
| Nitrogen atom-containing | | 1 | 1 | | 1 | | 1 | 1 | 1 |
| curing accelerator (D1) | | | | | | | | | |
| Nitrogen atom-containing | | | | 2 | | | | | |
| curing accelerator (D2) | | | | | | | | | |
| Nitrogen atom-containing | | | | | | | | | |
| curing accelerator (D3) | | | | | | | | | |
| Nitrogen atom-free | | | | | | 1 | | | |
| curing accelerator (D′1) | | | | | | | | | |
| Reaction inhibitor(E1) | | 0.2 | 0.2 | | 0.2 | 0.2 | | 0.2 | 0.2 |
| Reaction inhibitor(E2) | | | | 0.5 | | | | | |
| Inorganic filler(F1) | | 500 | 500 | 500 | 500 | 500 | 500 | 500 | 500 |
| Content ratio of inorganic | % by | 83.2 | 83.2 | 83.0 | 83.2 | 83.2 | 83.2 | 83.2 | 83.2 |
| filler(F) | mass | | | | | | | | |
| Amine compound | | | | | | | | | 19.5 |
| Flexibility of uncured resin | | ◯ | ◯ | ◯ | X | ◯ | ◯ | X | X |
| sheet | | | | | | | | | |
| Glass-transition temperature | ° C. | 180 | 170 | 170 | 210 | Unmoldable | 170 | 140 | 170 |
| Storage stability | % | 96 | 98 | 98 | 93 | 94 | Unmea- | 86 | Unmea- |
| | | | | | | | surable | | surable |
| Bending strength | MPa | 151 | 141 | 139 | 122 | Unmoldable | 111 | 81 | 90 |
| Adhesive force | MPa | 13.2 | 14.4 | 12.8 | 8.4 | Unmoldable | 9.8 | 2.4 | 16.4 |

What is claimed is:

1. A heat-curable epoxy resin composition comprising:
(A) a crystalline epoxy resin;
(B) a non-crystalline epoxy resin solid at 25° C.;
(C) a phenolic compound;
(D) a nitrogen atom-containing curing accelerator;
(E) a reaction inhibitor; and
(F) an inorganic filler.

2. The heat-curable epoxy resin composition according to claim 1, wherein the component (E) is at least one selected from the group consisting of boric acid, a boric ester compound and a phosphite ester compound.

3. The heat-curable epoxy resin composition according to claim 2, wherein the boric ester compound and the phosphite ester compound each contains a monovalent hydrocarbon group having 1 to 10 carbon atoms.

4. The heat-curable epoxy resin composition according to claim 1, wherein the component (D) is a urea-based curing accelerator or an imidazole-based curing accelerator.

5. The heat-curable epoxy resin composition according to claim 1, wherein the component (E) is contained in an amount of 0.01 to 5 parts by mass per a total of 100 parts by mass of the components (A), (B) and (C).

6. The heat-curable epoxy resin composition according to claim 1, wherein the component (F) is a spherical silica.

7. A heat-curable epoxy resin sheet wherein the heat-curable epoxy resin composition according to claim 1 is molded into the shape of a sheet.

8. The heat-curable epoxy resin sheet according to claim 7, wherein the heat-curable epoxy resin sheet has a thickness of 0.1 to 5 mm.
